(19) United States
(12) Patent Application Publication
(10) Pub. No.: US 2011/0067791 A1
(43) Pub. Date: Mar. 24, 2011

(54) OUTDOOR FURNITURE, POOL AND POOL-RELATED EQUIPMENT COVERINGS AND METHODS OF PRODUCTION THEREOF

(76) Inventor: Karyn Bussman, Stockton, CA (US)

(21) Appl. No.: 12/889,839

(22) Filed: Sep. 24, 2010

Related U.S. Application Data
(60) Provisional application No. 61/245,607, filed on Sep. 24, 2009.

(51) Int. Cl. B65D 65/02; B23P 17/04

(52) U.S. Cl. 150/154; 29/428

(57) ABSTRACT

An outdoor furniture, pool and pool-related equipment cover is described herein and includes at least one fabric, material or combination thereof, and at least one elastic fixture, at least one hook fixture or a combination thereof, wherein the at least one elastic fixture, at least one hook fixture or a combination thereof is coupled to the at least one fabric, material or combination thereof in order to at least partially cover a piece of outdoor furniture, a pool or a piece of pool-related equipment. Methods of producing an outdoor furniture, pool and pool-related equipment cover include: providing at least one fabric, material or combination thereof, providing at least one elastic fixture, at least one hook fixture or a combination thereof, and coupling the at least one fabric, material or combination thereof with the at least one elastic fixture, at least one hook fixture or a combination thereof, wherein the at least one elastic fixture, at least one hook fixture or a combination thereof is coupled to the fabric material in order to at least partially cover a piece of outdoor furniture, a pool or a piece of pool-related equipment.

This United States Utility application claims priority to U.S. Provisional Application Ser. No. 61/245,607 filed on Sep. 24, 2009, which is commonly-owned and incorporated herein in its entirety by reference.

### BACKGROUND

Pool covers and outdoor furniture covers are certainly not new, but until now have been poorly designed to address many of the needs of the modern homeowner. There are pool covers that are designed to only cover the pool without having matching functional covers for other pool-related equipment, such as slides, diving boards and outdoor furniture.

U.S. Pat. No. 5,916,031 describes an immovable cover for a diving platform that is designed specifically for a diving platform. This type of cover, while functional on one pool-related accessory, is not translatable to other accessories, because of its specific design.

Ideally, a cover system should be developed that is capable of covering all of the pool-related functional accessories, such as a slide, a diving board, a diving platform, an above-ground pool, along with each piece of outdoor furniture, such that the covered equipment is safe for children and pets, along with being easy and safe to install for the user. An ideal cover system is also attractive, such that when the equipment is not in use, the yard area looks as though it is coordinated and organized.

### SUMMARY

An outdoor furniture, pool and pool-related equipment cover is described herein and includes at least one fabric, material or combination thereof, and at least one elastic fixture, at least one hook fixture or a combination thereof, wherein the at least one elastic fixture, at least one hook fixture or a combination thereof is coupled to the at least one fabric, material or combination thereof in order to at least partially cover a piece of outdoor furniture, a pool or a piece of pool-related equipment.

Methods of producing an outdoor furniture, pool and pool-related equipment cover include: providing at least one fabric, material or combination thereof, providing at least one elastic fixture, at least one hook fixture or a combination thereof, and coupling the at least one fabric, material or combination thereof with the at least one elastic fixture, at least one hook fixture or a combination thereof, wherein the at least one elastic fixture, at least one hook fixture or a combination thereof is coupled to the fabric material in order to at least partially cover a piece of outdoor furniture, a pool or a piece of pool-related equipment.

### BRIEF DESCRIPTION OF THE FIGURES

FIG. 1 shows a conventional pool slide.

FIG. 2 shows a contemplated cover system on a pool slide.

FIGS. 3 and 4 show a contemplated hook system that can be used with a contemplated pool cover system.

FIG. 5 shows the back side of a pool slide showing the hook system as utilized in a contemplated embodiment.

### DETAILED DESCRIPTION

Such an ideal cover system has been developed that utilizes a resilient fabric material, along with a plurality of elastic and hook fixtures in order to secure each cover to the appropriate pool-related accessory in an easy and safe fashion.

An outdoor furniture, pool and pool-related equipment cover is described herein and includes at least one fabric, material or combination thereof, and at least one elastic fixture, at least one hook fixture or a combination thereof, wherein the at least one elastic fixture, at least one hook fixture or a combination thereof is coupled to the at least one fabric, material or combination thereof in order to at least partially cover a piece of outdoor furniture, a pool or a piece of pool-related equipment.

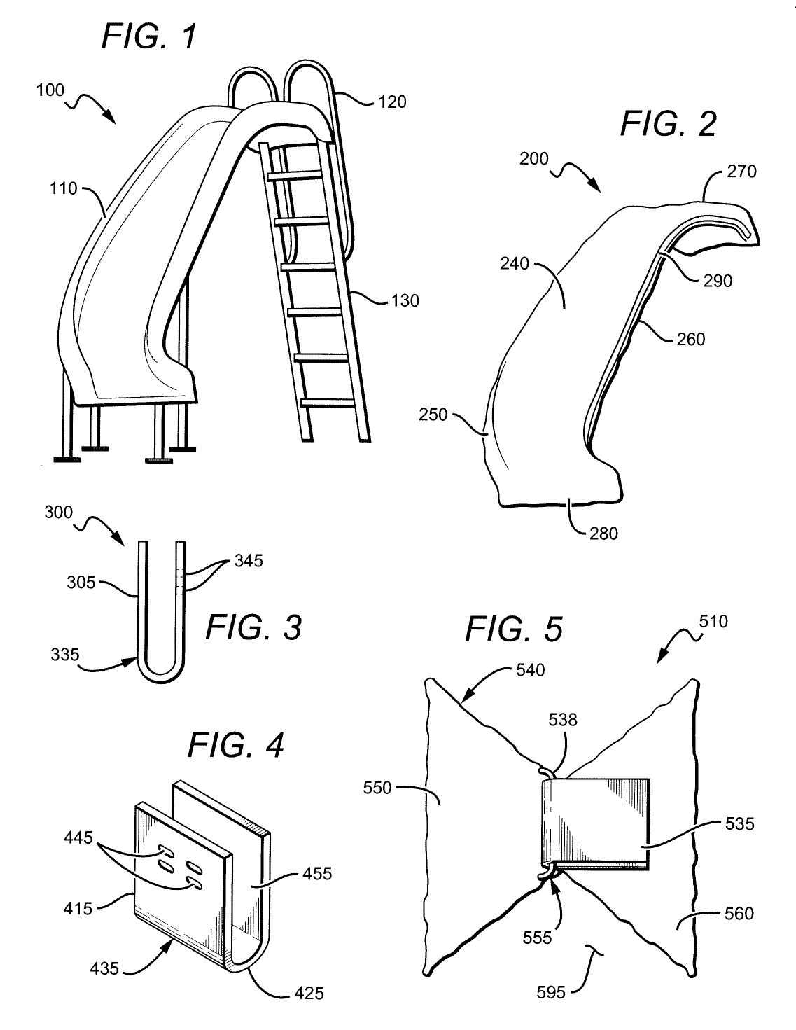

FIG. 1 shows a conventional pool slide 100, where the pool slide comprises a slide portion 110, a handle portion 120 and a ladder portion 130 used to climb to the top of the pool slide 100.

FIG. 2 shows a contemplated cover system 200 for the pool slide shown in FIG. 1 that comprises a fabric, material or combination thereof. The pool cover comprises a front side 240 of the material, a back side (not shown) of the material, a left side 250 of the material, a right side 260 of the material, a top side 270 of the material and a bottom side 280 of the material. A contemplated elastic fixture 290 is shown down the right side 260 of the cover system. In this embodiment, the at least one hook fixture is not shown, since it is found on or near the back side of the cover system 200.

It is contemplated that the fabric, material or combination thereof may comprise a layered material, wherein fabric, material or combinations thereof are layered at least in part to provide additional strength, waterproofing or weatherproofing to the cover system. It is further contemplated that the fabric, material or combination thereof may comprise pieces of fabric, material or a combination thereof that are coupled together to form a cover system that may provide additional strength in certain places on the cover system, may provide decorative elements or a combination thereof.

FIGS. 3 and 4 show part of a hook fixture or system 300, 400 that can be used with a contemplated pool cover system (not shown). FIG. 3 shows a side view 305 of a contemplated hook fixture 335. One can also see the slots, slits or holes 345 in the hook fixture 335 that is sewn or otherwise coupled in or with the fabric material of the cover. FIG. 4 shows a back view 415 of a contemplated hook fixture 435. One can also see the slots, slits or holes 445 in the hook fixture 435 that is sewn or otherwise coupled in or with the fabric material of the cover. A portion of the front side 425 of a contemplated part of a hook fixture 435 is shown, along with the middle portion 455 where the hook fixture 435 is coupled with a second part (not shown) to secure the hook system.

FIG. 5 shows the back side 595 of a contemplated pool slide 510 and contemplated pool slide cover 540 showing the hook system 555 as utilized in a contemplated embodiment. A contemplated hook system 555 comprises a receiving hook fixture 535 and an attaching hook fixture 538 wherein the two are designed to slideably couple with one another as shown. As used, once the contemplated pool slide cover 540 covers the pool slide 510, the user pulls the left side 550 and right side 560 of the pool slide cover 540 together in order to slideably couple the receiving hook fixture 535 to the attaching hook fixture 538. It is contemplated that a hook system may include coupling elements that are not traditional hooks and receivers. For example, a contemplated hook system may include a VELCRO™ system, a snap system, a button/button hole system, a zipper system, another suitable system or a combination thereof. As designed, a contemplated hook system comprises a system that functions to temporarily secure at least a part of the left back side and the right back side of the cover to one another.

As used herein, the term “coupled” with respect to the combination of the fabric, material or combination thereof and the hook system/elastic fixture means that they can be sewn together, molded together, adhesively coupled or another suitable way to couple fabric and/or material to elastic and hook fixtures. The term “coupled” with respect to the hook system means that the hook fixtures can be removably coupled to one another in order to secure the hook fixtures on the back of the cover system in order to securely hold the cover system to the equipment, pool or pool-accessory.

Some of the outdoor furniture, pool and pool-related equipment contemplated herein comprises an at least one elastic fixture, wherein the at least one elastic fixture runs at least in part lengthwise down the right side and the left side of the cover. In some embodiments, the at least one elastic fixture runs at least in part lengthwise down the right side, the left side, the bottom side and the top side of the cover. With respect to the at least one hook fixture, in some embodiments, the at least one hook fixture is coupled to the right side and the left side of the cover. In these embodiments, the at least one hook fixture is placed on or secured to the at least one fabric, material or combination thereof in such a manner that it can removably couple to another at least one hook fixture in order to form a hook system.

It is instructive to note that the slide comprises a combination elastic and hook system, wherein the elastic fixture allows the cover to securely attach on to the sides and top of the pool slide, while the hook system allows the slide cover to be secured under the slide, such that it cannot be easily removed by children or blown off by bad weather. This contemplated embodiment easily replaces those covers that hook to the sides and/or top of a slide, which can result in children easily unhooking the cover and/or the cover coming unhooked during bad weather.

Methods of producing an outdoor furniture, pool and pool-related equipment cover include: providing at least one fabric, material or combination thereof, providing at least one elastic fixture, at least one hook fixture or a combination thereof, and coupling the at least one fabric, material or combination thereof with the at least one elastic fixture, at least one hook fixture or a combination thereof, wherein the at least one elastic fixture, at least one hook fixture or a combination thereof is coupled to the fabric material in order to at least partially cover a piece of outdoor furniture, a pool or a piece of pool-related equipment.

As should be obvious, this type of contemplated cover system is also ideal for covering diving boards and diving platforms, in that the cover can be secured with the elastic sides and then hooked into place with the plurality of hooks. This type of contemplated cover system is also ideal to use with outdoor furniture, especially during the winter time and/or bad weather. The elastic fixes the cover to the furniture and then the hook system anchors the cover system to the furniture, so that the cover cannot be removed by children, bad weather or pets.

The cover system may be made out of any suitable fabric, material or combination thereof, depending on the geographic area where the cover system will be used, the décor of the home, and/or the budget of the consumer. In one embodiment, the cover system may be made out of SUNBRELLA™ material, which would be an ideal choice for sunny parts of the country and which would also be ideal where the cover system is being removed and put back on the pool accessory or furniture on a regular basis. In some embodiments, the fabric or material is resistant to mold and mildew. In some embodiments, the fabric or material is coated with a waterproofing composition or has a waterproofing composition or compound embedded in the material or fibers.

In some embodiments, the fabric, material or combination thereof is treated with a composition, such that at least a portion of the fabric will glow in the dark, will change colors in sunlight or rain and/or will be resistant to tampering by animals or insects. These additional compositions (such as in the case with glow in the dark materials) is designed to be both functional and attractive. The safety function comes at night when kids are outdoors. If the pool accessory and/or piece of outdoor furniture is glowing in the dark, then it is easily seen by the children as they are playing.

The plurality of elastic sections can run along each side of the cover system or may be strategically placed on the cover system in order to maximize the ability of the cover to fix onto the pool accessory or outdoor furniture piece. In this same fashion, the plurality of hooks and/or hook system may run along each side of the cover system or may be strategically placed on the cover system in order to maximize the ability of the cover to stay attached to the pool accessory and/or piece of outdoor furniture during extreme conditions.

Contemplated elastic and hook systems may comprise any suitable material or combination of materials, including non-corrosive metals, coated materials, plastics, composites, fabrics or combinations thereof.

Contemplated elastic and hook systems are also designed such that a single pool slide cover can fit a number of different sizes, shapes and lengths of pool slides. This function is important, because these cover systems are designed to be mass produced and sold to consumers, such that they do not need a customized cover system, but instead can buy one slide cover system and then utilize it as the pool slide is updated throughout the life of the pool.

Contemplated cover systems are designed to be removed, folded/rolled up and easily stored by the user, such that they are accessible and easy to put back on the pool accessory or piece of outdoor furniture after use. In some embodiments, the storage feature is coupled to the cover system, such that the cover system can be packed into a storage bag or can become its own storage bag through a series of hooks, buttons, VELCRO or another close feature.

Thus, specific embodiments and applications of outdoor furniture, pool and pool-related equipment cover systems and coverings and their methods of production have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. An outdoor furniture, pool and pool-related equipment cover, comprising:
at least fabric, material or combination thereof, and
at least one elastic fixture, at least one hook fixture or a combination thereof, wherein the at least one elastic fixture, at least one hook fixture or a combination thereof is coupled to the fabric material in order to at least partially cover a piece of outdoor furniture, a pool or a piece of pool-related equipment.

2. The outdoor furniture, pool and pool-related equipment cover of claim 1, wherein the fabric material is coated with a weatherproofing composition.

3. The outdoor furniture, pool and pool-related equipment cover of claim 1, wherein the fabric, material or combination thereof comprises SUNBRELLA™ material.

4. The outdoor furniture, pool and pool-related equipment cover of claim 1, wherein the cover comprises a front side, a back side, a left side and a right side, a top side and a bottom side.

5. The outdoor furniture, pool and pool-related equipment cover of claim 1, wherein the at least one elastic fixture runs at least in part lengthwise down the right side and the left side of the cover.

6. The outdoor furniture, pool and pool-related equipment cover of claim 1, wherein the at least one elastic fixture runs at least in part lengthwise down the right side, the left side, the bottom side and the top side of the cover.

7. The outdoor furniture, pool and pool-related equipment cover of claim 1, wherein the at least one hook fixture is coupled to the right side and the left side of the cover.

8. The outdoor furniture, pool and pool-related equipment cover of claim 1, wherein the at least one hook fixture on the right side of the cover corresponds to at least one hook fixture on the left side of the cover.

9. The outdoor furniture, pool and pool-related equipment cover of claim 1, wherein the at least one fabric, material or combination thereof comprises a layered material.

10. The outdoor furniture, pool and pool-related equipment cover of claim 1, wherein the at least one fabric, material or combination thereof comprises at least two pieces of fabric, material or a combination thereof.

11. The outdoor furniture, pool and pool-related equipment cover of claim 1, wherein the at least one hook system comprises a VELCRO™ system, a snap system, a button/button hole system, a zipper system or a combination thereof.

12. The outdoor furniture, pool and pool-related equipment cover of claim 1, wherein the at least one hook fixture forms a hook system.

13. A method of producing an outdoor furniture, pool and pool-related equipment cover, comprising:
providing at least one fabric, material or combination thereof,
providing at least one elastic fixture, at least one hook fixture or a combination thereof, and
coupling the at least one fabric, material or combination thereof with the at least one elastic fixture, at least one hook fixture or a combination thereof, wherein the at least one elastic fixture, at least one hook fixture or a combination thereof is coupled to the fabric material in order to at least partially cover a piece of outdoor furniture, a pool or a piece of pool-related equipment.
